(19) United States
(12) Patent Application Publication
(10) Pub. No.: US 2023/0268100 A1
(43) Pub. Date: Aug. 24, 2023

(54) METHOD OF MANUFACTURING ELECTRICALLY CONDUCTIVE FILM LAMINATE AND ELECTRICALLY CONDUCTIVE FILM LAMINATE

(71) Applicants: Shinji KOH, Kanagawa (JP); Takeshi WATANABE, Kanagawa (JP); Sho KUROMATSU, Kanagawa (JP); NIHON PLAST CO., LTD., Shizuoka (JP)

(72) Inventors: Kazuyuki ENDO, Shizuoka (JP); Shinji KOH, Kanagawa (JP); Takeshi WATANABE, Kanagawa (JP); Sho KUROMATSU, Kanagawa (JP)

(21) Appl. No.: 18/113,814

(22) Filed: Feb. 24, 2023

(30) Foreign Application Priority Data
Feb. 24, 2022 (JP) 2022-026891

(51) Int. Cl. H01B 13/00; H01B 13/34; H01B 1/04

(52) U.S. Cl. CPC H01B 13/0036; H01B 13/0016; H01B 13/34; H01B 1/04

(57) ABSTRACT

Provided is a method of manufacturing an electrically conductive film laminate 1 including a substrate to be laminated 10, an adhesive layer 20 formed on a surface of the substrate to be laminated 10, and an electrically conductive carbon film 30 formed on a surface of the adhesive layer 20, the method including: a first laminate manufacturing step for manufacturing a first laminate 110 including a forming substrate 40 for forming the electrically conductive carbon film 30 on a surface thereof, the electrically conductive carbon film 30 formed on a surface of the forming substrate 40, and the adhesive layer 20 formed on a surface of the electrically conductive carbon film 30; a thermocompression bonding step for manufacturing a second laminate 120 by bringing the adhesive layer 20 of the first laminate 110 into contact with the substrate to be laminated 10, and then performing heating and pressure bonding; and an etching step for manufacturing the electrically conductive film laminate 1 by etching the forming substrate 40 of the second laminate 120.

### CROSS REFERENCE TO RELATED APPLICATION

The present application is based on, and claims priority from the single prior Japanese Patent Application No. 2022-026891, filed on Feb. 24, 2022, the entire contents of which are incorporated herein by reference.

### TECHNICAL FIELD

The present disclosure relates to a method of manufacturing an electrically conductive film laminate, and to an electrically conductive film laminate.

### BACKGROUND

A single-wall carbon nanotube (SWCNT) has excellent mechanical, electrical, and thermal properties and high flexibility. Thus, for example, it is expected that an SWCNT film including an SWCNT will be applied as a next-generation flexible conductive material.

JP2009-298683A discloses a method of manufacturing a graphene sheet by immersing a laminate of a carbonization catalyst, a graphene sheet, a binder layer, and a substrate in an acid solution A as an etchant to remove the carbonization catalyst. JP2009-298683A also discloses that the binder layer is formed with a coating of a siloxane compound, an acrylic-based compound, or the like having high insulation properties.

### SUMMARY

However, the binder layer formed with the coating of JP2009-298683A usually includes a solvent component such as alcohol or ester. Thus, in the invention disclosed in JP2009-298683A, the solvent component and the like volatilizes in the hardening step for the binder layer, which tends to cause a decrease in adhesion between the binder layer and the graphene sheet and generation of bubbles.

Note that the graphene sheet laminate of Ni (carbonization catalyst film)/graphene sheet/binder layer/substrate in FIG. 3 of JP2009-298683A is manufactured using a known method. Thus, the graphene sheet laminate in FIG. 3 of JP2009-298683A does not seem to solve the issues of reduced adhesion between the binder layer and the graphene sheet and the generation of bubbles.

Thus, an electrically conductive film laminate including an electrically conductive carbon film having a stable film quality and a method of manufacturing the electrically conductive film laminate have not been known.

The present disclosure has been made in consideration of the above-described issues, which are inherent in the related art. An object of the present disclosure is to provide a method of manufacturing an electrically conductive film laminate having a stable film quality and to provide the electrically conductive film laminate.

A method of manufacturing an electrically conductive film laminate including a substrate to be laminated, an adhesive layer formed on a surface of the substrate to be laminated, and an electrically conductive carbon film formed on a surface of the adhesive layer, according to an embodiment, includes a first laminate manufacturing step for manufacturing a first laminate including a forming substrate for forming the electrically conductive carbon film on a surface thereof, the electrically conductive carbon film formed on a surface of the forming substrate, and the adhesive layer formed on a surface of the electrically conductive carbon film, a thermocompression bonding step for manufacturing a second laminate by bringing the adhesive layer of the first laminate into contact with the substrate to be laminated, and then performing heating and pressure bonding, and an etching step for manufacturing the electrically conductive film laminate by etching the forming substrate of the second laminate.

An electrically conductive film laminate according to an embodiment includes a substrate to be laminated, an adhesive layer formed on a surface of the substrate to be laminated, and an electrically conductive carbon film formed on a surface of the adhesive layer, wherein the electrically conductive carbon film is an SWCNT film that is a network structure of a single-wall carbon nanotube, and the adhesive layer includes a hardened product of an adhesive and metal ions.

The present disclosure is capable of providing a method of manufacturing an electrically conductive film laminate having a stable film quality and of providing the electrically conductive film laminate.

### BRIEF DESCRIPTION OF THE DRAWINGS

FIG. 1 is a cross-sectional view of an example of an electrically conductive film laminate according to a present embodiment.

FIG. 2 is a cross-sectional view of an example of a first laminate according to the present embodiment.

FIG. 3 is a cross-sectional view of an example of a CNT coated film composite according to the present embodiment.

FIG. 4 is a cross-sectional view of an example of an electrically conductive carbon film composite according to the present embodiment.

FIG. 5 is an SEM photograph of the surface of an example of an SWCNT film (electrically conductive carbon film) according to the present embodiment.

FIG. 6 is a cross-sectional view of an example of a pre-thermocompression bonding composite according to the present embodiment.

FIG. 7 is a cross-sectional view of an example of a second laminate according to the present embodiment.

FIG. 8 is an optical photograph illustrating an example of the second laminate according to the present embodiment.

FIG. 9 is a cross-sectional view illustrating an example of an etching step for the second laminate according to the present embodiment.

FIG. 10 is an SEM photograph of the surface of an example of the SWCNT film (electrically conductive carbon film) according to the present embodiment.

FIG. 11 is an optical photograph illustrating an example of the electrically conductive film laminate according to the present embodiment.

### DETAILED DESCRIPTION

An electrically conductive film laminate according to the present embodiment will be described in detail below using the drawings. Note that dimensional ratios in the drawings are exaggerated for convenience of the description and may differ from the actual ratios.

### [Electrically Conductive Film Laminate]

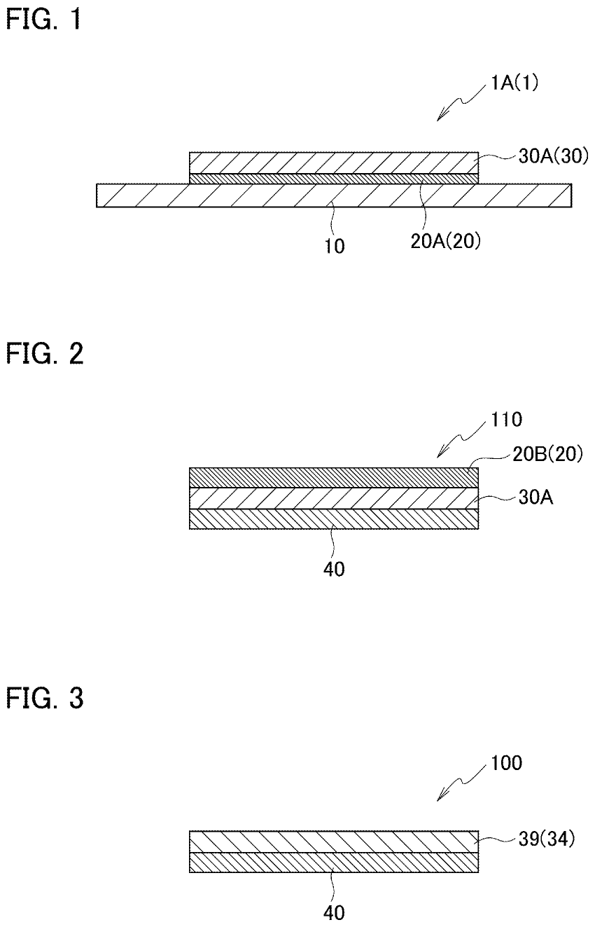

FIG. 1 is a cross-sectional view of an example of an electrically conductive film laminate according to the present embodiment. An electrically conductive film laminate 1A (1) in FIG. 1 includes a laminated substrate 10, an adhesive layer 20A (20) formed on the surface of the laminated substrate 10, and an electrically conductive carbon film 30A (30) formed on the surface of the adhesive layer 20A.

In the electrically conductive film laminate 1A, the laminated substrate 10, the adhesive layer 20A, and the electrically conductive carbon film 30A firmly adhere to each other through heating and pressure bonding in a thermocompression bonding step during manufacturing. In the electrically conductive film laminate 1A, the adhesive layer 20A includes a hardened product of an adhesive and metal ions 60 through contact with an etchant in an etching step performed after the thermocompression bonding step during manufacturing.

### (Substrate to be Laminated)

The substrate to be laminated 10 is a resin substrate on which the electrically conductive carbon film 30A is stacked with the adhesive layer 20A therebetween. Examples of the substrate to be laminated 10 used include polyethylene terephthalate (PET, glass transition temperature Tg: 69° C.), polybutylene terephthalate (PBT, glass transition temperature Tg: 50° C.), polyethylene (glass transition temperature Tg: −125° C.), polypropylene (glass transition temperature Tg: 0° C.), polyvinyl chloride (glass transition temperature Tg: 87° C.), polystyrene (glass transition temperature Tg: 100° C.), acrylonitrile-butadiene-styrene resin (ABS, glass transition temperature Tg: 80 to 125° C.), polymethyl methacrylate (glass transition temperature Tg: 90° C.), polyamide 6 (glass transition temperature Tg: 50° C.), polyamide 66 (glass transition temperature Tg: 50° C.), polyacetal (glass transition temperature Tg: −50° C.), polycarbonate (glass transition temperature Tg: 150° C.), polyphenylene sulfide (glass transition temperature Tg: 126° C.), polyurethane (glass transition temperature Tg: −20° C.), polyethersulfone (glass transition temperature Tg: 230° C.), polyphenylene oxide (glass transition temperature Tg: 104 to 120° C.), polyamideimide (glass transition temperature Tg: 275° C.), polylactic acid (glass transition temperature Tg: 57° C.), polytetrafluoroethylene (glass transition temperature Tg: 126° C.), ethylene-vinyl acetate copolymer (EVA, glass transition temperature Tg: −42° C.), polyacrylonitrile (glass transition temperature Tg: 104° C.), and polyvinylidene fluoride (glass transition temperature Tg: 35° C.). Of these, PET resin has a relatively low glass transition temperature of 69° C. and a high heat-resistant temperature of 220° C., which makes the material highly stable and flexible during thermocompression bonding. Thus, it is highly preferable that the substrate to be laminated 10 be made from a PET resin because it easily and firmly adheres to the adhesive layer 20A.

Note that the electrically conductive film laminate 1A manufactured through the thermocompression bonding step usually has an interface at which the substrate to be laminated 10 and the adhesive layer 20A firmly bond to each other. This will be described below.

(Adhesive Layer)

The adhesive layer 20A is a layer that is arranged between the substrate to be laminated 10 and the electrically conductive carbon film 30A, and then to which the substrate to be laminated 10 and the electrically conductive carbon film 30A are firmly adhered through heating and pressure bonding. Specifically, the adhesive layer 20A includes a hardened product of the adhesive that is formed when the adhesive is hardened through heating and pressure bonding. In addition, the electrically conductive film laminate 1A usually tends to include metal ions 60 in the adhesive layer 20A due to contact with an etchant 50 in the etching step during manufacturing. That is, the adhesive layer 20A may include the hardened product of the adhesive and the metal ions 60.

The metal ions 60 used include metal ions contained in the etchant 50, and metal ions derived from a forming substrate 40, which are generated when the forming substrate 40 comes in contact with the etchant 50 and is etched. When metal ions are included in the adhesive layer 20A, a doping effect to improve transfer of electrons between the electrically conductive carbon film 30A and the substrate to be laminated 10 via the adhesive layer 20A occurs, which is preferable because the conductive effect as a whole of the electrically conductive film laminate 1A is improved.

For example, when the etchant 50 is an iron-containing liquid such as an iron nitrate solution or an iron chloride solution, Fe²⁺ resulting from reduction of Fe³⁺ in the etchant 50 may be included in the adhesive layer 20A as the metal ions 60.

Also, when the forming substrate 40 is a Cu plate, Cu′ generated when the Cu plate 40 comes in contact with the etchant 50 and is etched may be included in the adhesive layer 20A as the metal ions 60. Thus, the metal ions included in the adhesive layer 20A may include Cu²⁺ and/or Fe²⁺.

It is preferable that the adhesive layer 20A be manufactured using the etchant 50 having a metal ion concentration of 0.52 mol/L or more because the content of metal ions included in the adhesive layer 20A increases and the conductive effect of the electrically conductive carbon film 30A (SWCNT film) of the electrically conductive film laminate 1A is likely to increase.

Examples of the adhesive used include an acrylic-based adhesive, a modified acrylic-based adhesive, a silicone-based adhesive, a urethane-based adhesive, and a rubber-based adhesive. Of these, an acrylic-based adhesive and a modified acrylic-based adhesive are preferable because they have high transparency and high heat resistance and can be used for TOM forming or the like. Here, a modified acrylic-based adhesive means an adhesive in which a functional group that easily adsorbs water is imparted to impart hydrophilicity and the polarity of the resin is increased.

Generally, when the polarity of molecules is increased, the gap between electrons of the molecules increases and thus the attraction force (intermolecular force) between the molecules increases. Thus, as the polarity of resin increases, water constituted by highly polar molecules is more easily adsorbed to the highly polar resin molecules, thereby imparting hydrophilicity to the resin. In contrast, as the polarity of resin decreases, water constituted by molecules having high polarity is less easily adsorbed to the molecules having low polarity, thereby imparting hydrophobicity to the resin.

An example of the modified acrylic-based adhesive used is an acrylic-based adhesive modified by adding a hydroxyl group (—OH), a carboxyl group (—COOH), an amino group (—NH₂), a carbonyl group (—CO), or the like to the terminal of a molecule. More specifically, the modified acrylic-based adhesive used is an adhesive constituting an adhesive layer of modified acrylic-based adhesive G25 manufactured by NEION Film Coatings Corp. is used.

The acrylic-based adhesive and the modified acrylic-based adhesive are preferable because they have high heat resistance and high transparency and thus it is possible to manufacture the electrically conductive film laminate 1A, which has a three-dimensional complicated shape, using TOM forming. Also, the modified acrylic-based adhesive is more preferable because metal ions are easily included in the adhesive layer 20A.

The adhesive layer 20A can include a hardened product of an acrylic-based adhesive. An acrylic-based adhesive is preferable because the glass transition temperature is relatively low and thus the adhesive layer 20A can easily and firmly adhere to the substrate to be laminated 10, the electrically conductive carbon film 30A, and the like. Since transparency, heat resistance, and elongation tracking properties are high when the hardened product of an acrylic-based adhesive is included, during manufacturing it is possible to absorb outgas and a minute amount of water generated from the substrate to be laminated 10. Thus, it is preferable that the adhesive layer 20A include a hardened product of an acrylic-based adhesive because the adhesive layer 20A absorbs gas and water, thereby preventing bubbles and floating from occurring in the adhesive layer 20A.

Examples of the acrylic-based adhesive used include an ethyl acrylate-based adhesive, a methyl acrylate-based adhesive, a butyl acrylate-based adhesive, and a methyl methacrylate-based adhesive. An example of the modified acrylic-based adhesive used is an adhesive modified by imparting a functional group that is easy to adsorb water to a monomer of the above-described adhesive. That is, in the present embodiment, a hardened product of an acrylic-based adhesive can be a hardened product of an acrylic-based adhesive having water absorbency.

Note that an acrylic-based adhesive and a modified acrylic-based adhesive usually have a smaller molecular weight than that of the general PMMA polymer. Thus, the glass transition temperatures of the acrylic-based adhesive and the modified acrylic-based adhesive are usually lower than that of the general PMMA polymer of 90° C., and are 70 to 80° C., for example. It is preferable that a hardened product of an adhesive be made from a hardened product of an acrylic-based adhesive or a modified acrylic-based adhesive because the lower glass transition temperature makes it easy to adhere firmly to the substrate to be laminated 10, the electrically conductive carbon film 30A, and the like.

The adhesive layer 20A is interposed between the substrate to be laminated 10 and the electrically conductive carbon film 30A, and the thickness thereof usually decreases after heating and pressure bonding compared to before heating and pressure boding. That is, in the thermocompression bonding step of the method of manufacturing the electrically conductive film laminate 1A, the adhesive arranged between the substrate to be laminated 10 and the electrically conductive carbon film 30A decreases in thickness through the heating and pressure bonding to become the adhesive layer 20A.

Note that during heating and pressure bonding, it is usually easy for materials constituting each layer to firmly bond to each other at the interface between the adhesive layer 20A and the substrate to be laminated 10 and at the interface between the adhesive layer 20A and the electrically conductive carbon film 30A. For example, during heating and pressure bonding, entanglement occurs between molecules of the adhesive constituting the adhesive layer 20A and resin molecules constituting the substrate to be laminated 10 due to micro-Brownian motion and the like of the resin molecules, and thus the adjacent layers easily and firmly bond. In this way, the electrically conductive film laminate 1A manufactured through the thermocompression bonding step usually has an interface at which the adhesive layer 20A and the substrate to be laminated 10 firmly bond to each other and an interface at which the adhesive layer 20A and the electrically conductive carbon film 30A firmly bond to each other.

In addition, when the adhesive is an acrylic-based adhesive or a modified acrylic-based adhesive, the adhesive is usually heat-pressed at a temperature higher than its glass transition temperature during heating and pressure bonding. Thus, when the adhesive is an acrylic-based adhesive or a modified acrylic-based adhesive, a solvent component included in the resin constituting the adhesive desorbs during heating and pressure bonding, and the adhesive layer 20A becomes a strong film.

The thickness of the adhesive layer 20A is, for example, 5 to 100 μm, preferably 10 to 50 μm, more preferably 20 to 30 μm. It is preferable that the thickness of the adhesive layer 20A be within the above-described ranges because transparency and metal ion adsorption are well maintained.

(Electrically Conductive Carbon Film)

The electrically conductive carbon film 30A (30) is an electrically conductive film including a carbon material. FIG. 5 is an SEM photograph of the surface of one example of the electrically conductive carbon film according to the present embodiment. The electrically conductive carbon film 30A in FIG. 5 is an SWCNT film 30A, which is a network structure of a single-wall carbon nanotube 35. The SWCNT film 30A usually has many gaps therein.

In the electrically conductive film laminate 1A, the electrically conductive carbon film 30 is constituted by the SWCNT film 30A, but as a modification of the electrically conductive film laminate 1A, an electrically conductive carbon film 30 other than the SWCNT film may be used. For example, a modified example of the electrically conductive film laminate 1A can use an electrically conductive carbon film 30 including a graphene film.

The center diameter of the single-wall carbon nanotube 35 included in the SWCNT film 30A is, for example, 0.5 to 5 nm, preferably 1 to 3 nm. The length of the single-wall carbon nanotube 35 included in the SWCNT film 30A is, for example, 1 to several 10 μm.

The thickness of the SWCNT film 30A is, for example, 50 to 500 nm, preferably 100 to 200 nm.

It is preferable that the electrically conductive carbon film 30 be constituted by the SWCNT film 30A because the SWCNT film 30A and the adhesive layer 20A easily and firmly adhere to each other through heating and pressure bonding in the thermocompression bonding step during manufacturing of the electrically conductive film laminate 1A. Strong adhesion between the SWCNT film 30A and the adhesive layer 20A occurs, for example, through heating and pressure bonding in the thermocompression bonding step, in which the single-wall carbon nanotube 35 constituting the SWCNT film 30A and the molecules of the adhesive constituting the adhesive layer 20A are entangled.

As described above, the electrically conductive film laminate 1A manufactured through the thermocompression bonding step usually has an interface at which the electrically conductive carbon film 30A and the adhesive layer 20A firmly bond to each other.

(Effects)

The electrically conductive film laminate 1A is capable of providing an electrically conductive film laminate having a stable film quality.

In addition, when the adhesive layer 20A of the electrically conductive film laminate 1A includes the metal ions 60, it is possible to further increase the conductive effect of the SWCNT film (electrically conductive carbon film) 30A of the electrically conductive film laminate 1A.

The electrically conductive film laminate 1A is manufactured, for example, through the following method of manufacturing an electrically conductive film laminate.

### [Method of Manufacturing Electrically Conductive Film Laminate]

A method of manufacturing an electrically conductive film laminate is a method of manufacturing the electrically conductive film laminate 1A (1) including a substrate to be laminated 10, an adhesive layer 20A (20) formed on the surface of the substrate to be laminated 10, and an electrically conductive carbon film 30A (30) formed on the surface of the adhesive layer 20A. The method of manufacturing an electrically conductive film laminate includes a first laminate manufacturing step, a thermocompression bonding step, and an etching step.

(First Laminate Manufacturing Step)

The first laminate manufacturing step is a step of manufacturing a first laminate 110 including the forming substrate 40 for forming the electrically conductive carbon film 30 on the surface thereof, the electrically conductive carbon film 30 formed on the surface of the forming substrate 40, and the adhesive layer 20 formed on the surface of the electrically conductive carbon film 30.

FIG. 2 is a cross-sectional view of an example of the first laminate according to the present embodiment. As illustrated in FIG. 2, the first laminate 110 includes the forming substrate 40, the SWCNT film 30A (30), and the adhesive layer 20B (20). The description of the SWCNT film 30A is omitted because it is the same as that described above in the “Electrically conductive film laminate” section. The adhesive layer 20B is the same as the adhesive layer 20A described above in the “Electrically conductive film laminate” section except that it does not usually include the metal ions included in the adhesive layer 20A.

Here, the reason why the adhesive layer 20B usually does not include the metal ions is that the adhesive layer 20B is not in contact with the etchant 50 in the etching step described below. That is, since the adhesive layer 20A described above in the “Electrically conductive film laminate” section is the adhesive layer 20, which has come into contact with the etchant 50 in the etching step, it usually includes metal ions. In contrast, since the adhesive layer 20B is the adhesive layer 20, which has not yet been in contact with the etchant 50 in the etching step, it usually does not include metal ions.

<Forming Substrate>

The forming substrate 40 is a metal substrate for forming the SWCNT film 30A (30) on the surface thereof. As a material of the forming substrate 40, a metal containing, for example, Cu, Ni, Ge, Co, or Ru is used. It is preferable that the material of the forming substrate 40 be made from the above-described metals because heat resistance is imparted to the forming substrate 40 and etching is easily performed.

From thereamong, it is preferable that the forming substrate 40 be a Cu plate made from a Cu-containing metal because alloy formation with a carbon film is unlikely to occur at the interface due to an inherently low level of carbon, etching is easily performed, and it is inexpensive.

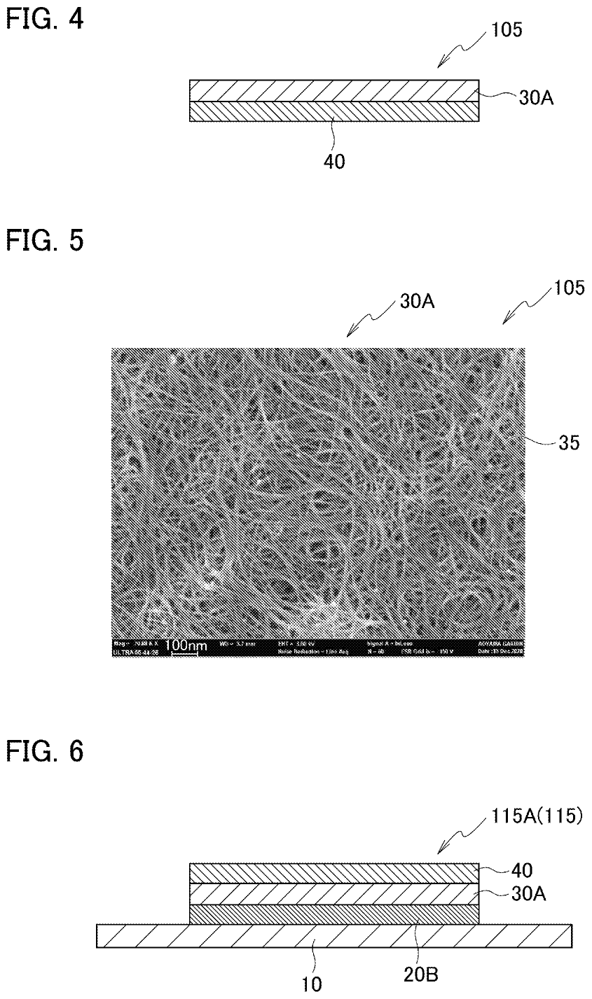

FIG. 3 is a cross-sectional view of an example of a CNT coated film composite according to the present embodiment. FIG. 4 is a cross-sectional view of an example of an electrically conductive carbon film composite according to the present embodiment. The first laminate 110 in FIG. 2 is manufactured by forming the adhesive layer 20B on the surface of the SWCNT film 30A (30) of an electrically conductive carbon film composite 105 in FIG. 4. The electrically conductive carbon film composite 105 in FIG. 4 is manufactured using the CNT coated film composite 100 in FIG. 3. Thus, when the adhesive layer 20B is formed on the surface of the SWCNT film 30A (30) of the electrically conductive carbon film composite 105 in FIG. 4 manufactured using the CNT coated film composite 100 in FIG. 3, the first laminate 110 in FIG. 2 is manufactured.

The CNT coated film composite 100 in FIG. 3 includes the forming substrate 40, and CNT ink 34 or a CNT coated film 39 in which the viscosity of the CNT ink 34 is increased, which is applied on the surface of the forming substrate 40.

The electrically conductive carbon film composite 105 in FIG. 4 includes the forming substrate 40 and the SWCNT film 30A (30) formed on the surface of the forming substrate 40. The SWCNT film 30A of the electrically conductive carbon film composite 105 is obtained by removing a dispersant and a dispersion solvent from the CNT coated film 39 of the CNT coated film composite 100 in FIG. 3.

When the following application step and removal step are performed on the CNT coated film composite 100 in FIG. 3, the electrically conductive carbon film composite 105 in FIG. 4 is obtained.

[Application Step]

The application step is a step of forming the CNT coated film 39 by applying the CNT ink 34 including the single-wall carbon nanotube 35, a dispersant, and a dispersion solvent onto the forming substrate 40 using a spin coating method.

Since the single-wall carbon nanotube 35 included in the CNT ink 34 is the same as that described above in the “Electrically conductive film laminate” section, the description thereof will be omitted.

Examples of the dispersant used include ethylcellulose, sodium dodecyl sulfate, and sodium dodecylbenzene sulfate. Ethylcellulose is preferable because the viscosity of the CNT ink 34 can be easily prepared and the single-wall carbon nanotube 35 can be dispersed uniformly.

Examples of the dispersion solvent used include N-methylpyrrolidone and dimethylformamide. N-methylpyrrolidone is preferable because of its excellent solution stability.

The concentration of the single-wall carbon nanotube 35 in the CNT ink 34 is, for example, 0.01 to 0.5 mass %, preferably 0.05 to 0.2 mass %, more preferably 0.08 to 0.12 mass %, with respect to 100 mass % of the CNT ink 34. It is preferable that the concentration of the single-wall carbon nanotube 35 be within the above-described ranges because it is easy to form a uniform SWCNT film.

The concentration of the dispersant in the CNT ink 34 is, for example, 0.05 to 3 mass %, preferably 0.5 to 1.5 mass %, more preferably 0.8 to 1.2 mass %, with respect to 100 mass % of the CNT ink 34. It is preferable that the concentration of the single-wall carbon nanotube 35 be within the above-described ranges because the dispersion efficiency of the single-wall carbon nanotube is high.

The CNT ink 34 applied on the forming substrate 40 of the CNT coated film composite 100 in FIG. 3 becomes the CNT coated film 39 covering the surface of the forming substrate 40. Note that the components of the CNT coated film 39 may be the same as those of the CNT ink 34, or may be those of the CNT ink 34 from which part or all of the dispersion solvent and the like have been removed.

[Removal Step]

The removal step is a step of removing the dispersant and the dispersion solvent derived from the CNT ink 34 from the CNT coated film 39. Note that when the dispersion solvent does not exist in the CNT coated film 39, the removal step is a step of removing the dispersant from the CNT coated film 39.

In the removal step, for example, the CNT coated film 39 is heat-treated at 350° C. or higher, preferably at 350 to 400° C. It is preferable that the heat treatment temperature be within the above-described ranges because the dispersant and the solvent are efficiently removed and the thermal damage of the CNT coated film 39 is small.

In the first laminate manufacturing step, the application step and the removal step are performed first to obtain the electrically conductive carbon film composite 105 in FIG. 4. In the first laminate manufacturing step, the adhesive layer 20B is then formed on the surface of the electrically conductive carbon film 30A of the electrically conductive carbon film composite 105 using a known method to obtain the first laminate 110 in FIG. 2.

(Thermocompression Bonding Step)

The thermocompression bonding step is a step in which the adhesive layer 20B (20) of the first laminate 110 is brought into contact with the substrate to be laminated 10 and then the second laminate 120 is manufactured through heating and pressure bonding.

FIG. 6 is a cross-sectional view of an example of a pre-thermocompression bonding composite 115 according to the present embodiment. The pre-thermocompression bonding composite 115A (115) in FIG. 6 includes the laminated substrate 10, the adhesive layer 20B (20) formed on the surface of the laminated substrate 10, and the electrically conductive carbon film 30A (30) formed on the surface of the adhesive layer 20B. The pre-thermocompression bonding composite 115A is a laminate before heating and pressure bonding in the thermocompression bonding step. The pre-thermocompression bonding composite 115A is a precursor of a second laminate 120 that is a laminate after heating and pressure bonding in the thermocompression bonding step.

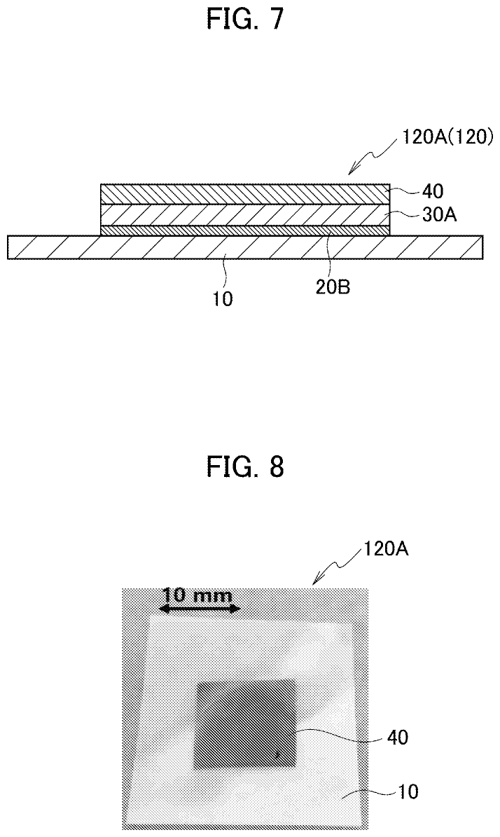

FIG. 7 is a cross-sectional view of an example of the second laminate 120 according to the present embodiment. The second laminate 120A (120) in FIG. 7 includes the laminated substrate 10, the adhesive layer 20A (20) formed on the surface of the laminated substrate 10, and the electrically conductive carbon film 30A (30) formed on the surface of the adhesive layer 20A. The second laminate 120A is a laminate after heating and pressure bonding in the thermocompression bonding step.

When the pre-thermocompression bonding composite 115A in FIG. 6 undergoes heating and pressure bonding, the second laminate 120A in FIG. 7 is obtained. FIG. 8 is an optical photograph illustrating an example of the second laminate 120A (120) according to the present embodiment.

When the temperature of the heating and pressure bonding is the glass transition temperature or higher of the substrate to be laminated 10, preferably the glass transition temperature+5° C. or higher of the substrate to be laminated 10, the molecules of the resin constituting the substrate to be laminated 10 and the molecules of the adhesive constituting the adhesive layer 20B (20) are likely to become entangled. It is preferable that such entanglement occur because the substrate to be laminated 10 and the adhesive layer 20B (20A, 20) easily and firmly bond to each other.

Also, it is preferable that the temperature of heating and pressure bonding be the glass transition temperature or higher of the adhesive constituting the adhesive layer 20B (20), preferably the glass transition temperature+5° C. or higher of the adhesive. When the temperature of the heating and pressure bonding is within the above-described ranges, entanglement is likely to occur between the molecules of the adhesive constituting the adhesive layer 20B, and one or more of the molecules of the resin constituting the substrate to be laminated 10 and the single-wall carbon nanotube 35 constituting the SWCNT film 30A. It is preferable that such entanglement occur because the substrate to be laminated 10 and one or both of the adhesive layer 20B (20A, 20) and the SWCNT film 30A easily and firmly bond to each other.

The temperature of the above-described heating and pressure bonding is, for example, 100° C. or higher, preferably 120 to 130° C. It is preferable that the temperature of the heating and pressure bonding be within the above-described range because layers firmly bond to each other and the thermal history due to heating can be reduced to suppress degradation.

For example, when PET having a glass transition temperature of 69° C. is used as the substrate to be laminated 10 and PMMA having a glass transition temperature of 90° C. is used as the adhesive, the temperature of heating and pressure bonding is set to, for example, 100° C. or higher. It is preferable that the temperature of heating and pressure bonding be within the above-described ranges because the substrate to be laminated 10 and one or both of the adhesive layer 20B (20A, 20) and the SWCNT film 30A easily and firmly bond to each other.

The applied load of the above-described heating and pressure bonding can be, for example, 2 to 8 kN, preferably 4 to 6 kN. The pressurization time of the above-described heating and pressure bonding can be, for example, 30 to 75 seconds, preferably 45 to 60 seconds.

The thermocompression bonding step can be performed, for example, through TOM (three dimension overlay method, three-dimensional surface decoration) forming.

The temperature of thermocompression bonding in the TOM forming method is, for example, 100° C. or higher, preferably 120 to 130° C. It is preferable that the temperature of heating and pressure bonding be within the above-described ranges because elongation tracking properties of the substrate to be laminated 10 are good and the adhesive effect of the adhesive is well developed, and thus the close adhesion between the substrate to be laminated 10 and the adhesive layer 20B is stable.

In the TOM forming method, the elongation of the substrate to be laminated 10 in heating and pressure bonding is set to, for example, 100% or more, or 100 to 150%. It is preferable that the elongation of the substrate to be laminated 10 be within the above-described ranges because it is easy to obtain the second laminate 120A, which is stable without having film breakage, wrinkle generation, peeling of the terminal part, flaking, and the like. Here, “elongation 100%” of the substrate to be laminated 10 means that the length of the substrate to be laminated 10 after elongation becomes twice the length of the substrate to be laminated 10 before elongation.

(Etching Step)

The etching step is a step of etching the forming substrate 40 of the second laminate 120A (120) and manufacturing the electrically conductive film laminate 1A (1).

Specifically, the etching step is a step of etching the forming substrate 40 by immersing the second laminate 120 in the etchant 50 for etching the metal included in the forming substrate 40. For example, when the forming substrate 40 is a Cu plate made from a Cu-containing metal, the etching step is a step of etching the forming substrate 40 by immersing the second laminate 120A in the etchant 50 for etching Cu.

There are no particular limitations regarding the etchant 50 for etching Cu as long as Cu can be etched and the material of the substrate to be laminated 10, such as PET, is not altered. Examples of the etchant 50 for etching Cu used include an iron nitrate solution, an iron chloride solution, and an acid such as hydrochloric acid or sulfuric acid. Among these, the etchant 50 made from one or both of an iron nitrate solution and an iron chloride solution is preferable because it has no or small adverse effect that causes alteration in the material of the substrate to be laminated 10, such as PET.

For example, one or both of an iron nitrate solution and an iron chloride solution are used as the etchant 50. The concentration of the iron nitrate solution or the iron chloride solution is set to, for example, 0.5 to 7.0 M. Note that it is preferable that the concentration of metal ions be high in the etchant 50 because metal ions are more likely to be included in the adhesive layer 20A of the electrically conductive film laminate 1A.

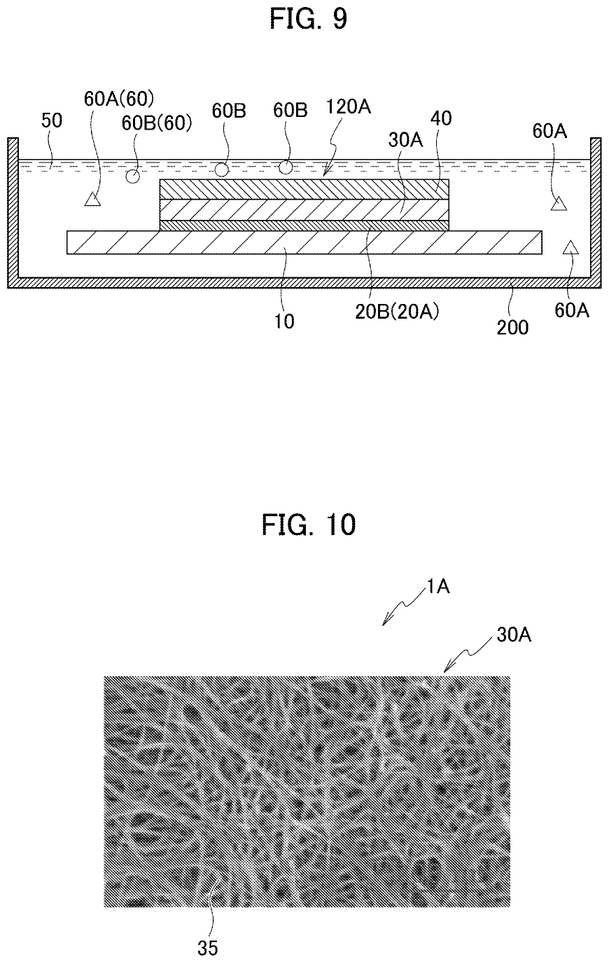

FIG. 9 is a cross-sectional view of an example of the etching step for the second laminate 120 according to the present embodiment. As illustrated in FIG. 9, the etching step is performed, for example, by immersing the second laminate 120 in an etching tank 200 filled with the etchant 50.

Specifically, FIG. 9 illustrates an example in which metal ions 60B (60) are generated from the forming substrate 40 by etching the forming substrate 40 with the etchant 50 including the metal ions 60A (60).

As illustrated in FIG. 9, the forming substrate 40 of the second laminate 120 discharges the metal ions 60B into the etchant 50 when the forming substrate 40 is etched with the etchant 50. Thus, as etching proceeds in this step, the etchant 50 has included the metal ions 60A derived from the etchant 50 and the metal ions 60B derived from the forming substrate 40.

When etching proceeds further in this step and the forming substrate 40 is completely removed, the electrically conductive film laminate 1A including the laminated substrate 10, the adhesive layer 20A, and the SWCNT film (electrically conductive carbon film) 30A illustrated in FIG. 1 is obtained in the etchant 50. FIG. 10 is an SEM photograph of the surface of one example of the SWCNT film (electrically conductive carbon film) 30A according to the present embodiment.

As illustrated in FIG. 10, the SWCNT film (electrically conductive carbon film) 30A usually has many gaps therein. Thus, the metal ions 60 (60A, 60B) such as the metal ions 60A and 60B in the etchant 50 permeate the SWCNT film (electrically conductive carbon film) 30A and permeate the adhesive layer 20B. Thus, when the metal ions 60 permeate the adhesive layer 20B, the adhesive layer 20A including the metal ions 60 is obtained. The metal ions 60 included in the adhesive layer 20B usually have positive charges. Note that when the adhesive layer 20B includes a hardened product of a modified acrylic-based adhesive having a highly polar functional group and the like and having water absorbency, it becomes easier for the metal ions 60 to permeate the adhesive layer 20B.

The metal ions 60 included in the adhesive layer 20A act as an acceptor (p-type impurities) at the interface with the SWCNT film (electrically conductive carbon film) 30A. Thus, in the adhesive layer 20A including the metal ions 60, a doping effect occurs at the interface between the adhesive layer 20A and the SWCNT film (electrically conductive carbon film) 30A, in which the exchange of electrons occurs, and the conductive effect of the SWCNT film (electrically conductive carbon film) 30A in the electrically conductive film laminate 1A is enhanced. Note that it is preferable that the adhesive layer 20B include a hardened product of a modified acrylic-based adhesive having a highly polar functional group and the like and having water absorbency because the doping effect appears more and the conductive effect of the SWCNT film (electrically conductive carbon film) 30A in the electrically conductive film laminate 1A is more enhanced.

(Effects)

In the method of manufacturing the electrically conductive film laminate according to the present embodiment, it is possible to provide a method of manufacturing the electrically conductive film laminate 1A having a stable film quality.

In the method of manufacturing the electrically conductive film laminate according to the present embodiment, in which the etching step is performed after the thermocompression bonding step, a transfer step for the electrically conductive carbon film in water as in the conventional method is unnecessary.

### EXAMPLES

The present disclosure will be described in more detail below using examples, but the disclosure is not limited to these examples.

### Example 1

(First Laminate Manufacturing Step)

A Cu plate (thickness: 125 μm) was prepared as a forming substrate. As raw materials of CNT ink, eDIPS EC1.5 (center diameter: 1 to 3 nm) manufactured by Meijo Nano Carbon Co., Ltd. as an SWCNT, ethyl cellulose as a dispersant, and N-methylpyrrolidone as a dispersion solvent were prepared. The CNT ink was prepared by mixing eDIPS EC 1.5, ethyl cellulose, and N-methylpyrrolidone in such a manner that the content of eDIPS EC 1.5 was 0.1 mass % and the content of ethyl cellulose was 1 mass %.

[Application Step]

A CNT coated film having a thickness of 150 nm was formed on the surface of the Cu plate by applying the CNT ink on the surface of the Cu plate using the spin coating method.

[Removal Step]

The Cu plate on which the CNT coated film was formed was heat-treated at 350° C. for 30 minutes, and thus an electrically conductive carbon film composite in which a 150 nm-thick SWCNT film was formed on the surface of the Cu plate was obtained. FIG. 5 illustrates an SEM photograph of the surface of the SWCNT film.

Modified acrylic-based adhesive G25 manufactured by NEION Film Coatings Corp. was prepared as the adhesive layer 20B. The G25 had a modified acrylic-based adhesive layer having a thickness of 25 μm, a PET release layer having a thickness of 38 μm covering one side of the adhesive layer, and a PET release layer having a thickness of 75 μm covering the other side of the adhesive layer. The modified acrylic-based adhesive layer was a sheet made from a modified PMMA (glass transition temperature: 90° C.).

A modified acrylic-based adhesive layer of G25, which has a thickness of 25 μm, was bonded to the surface of the SWCNT film of the electrically conductive carbon film composite, and thus a first laminate having the Cu plate, the SWCNT film, and the modified acrylic-based adhesive layer was obtained.

(Thermocompression Bonding Step)

A PET plate (thickness: 125 μm, glass transition temperature: 69° C.) was prepared as a substrate to be laminated.

The modified acrylic-based adhesive layer of the first laminate was brought into contact with the surface of the PET plate, and TOM forming was performed. The conditions for TOM forming were set to a heating temperature of 100° C., an applied load of 5 kN, and a pressurization time of 60 seconds (1 minute).

A second laminate having the PET plate, the modified acrylic-based adhesive layer, the SWCNT film, and the Cu plate was obtained through TOM forming. An optical photograph of the second laminate is shown in FIG. 8.

(Etching Step)

The etching tank 200 illustrated in FIG. 9 was prepared, and a Cu etchant of an iron chloride solution (6.9 M) at 20° C. was stored in the tank. When the second laminate was immersed in the Cu etchant for 18 minutes and the Cu plate of the second laminate was removed by etching, an electrically conductive film laminate including the PET plate, the modified acrylic-based adhesive layer, and the SWCNT film was obtained. FIG. 10 illustrates an SEM photograph of the surface of the SWCNT film (electrically conductive carbon film) of the electrically conductive film laminate.

(Evaluation)

The electrical properties of the obtained electrically conductive film laminate were measured.

<Electrical Conductivity>

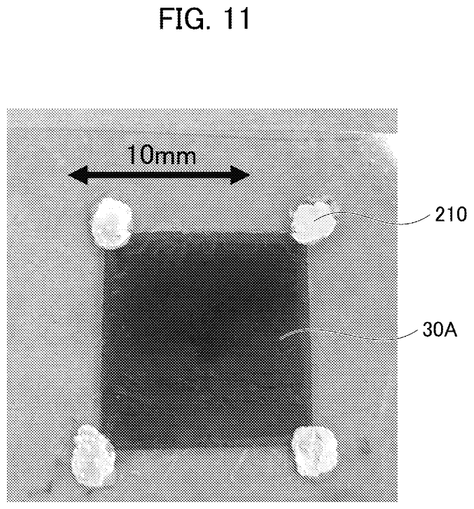

The electrical conductivity was measured for the obtained SWCNT film (electrically conductive carbon film) of the electrically conductive film laminate. A test piece illustrated in FIG. 11 was prepared from the obtained electrically conductive film laminate. In the test piece illustrated in FIG. 11, four Ag terminals 210 were prepared by applying Ag paste to the four corners of the surface on the SWCNT film (electrically conductive carbon film) of the electrically conductive film laminate.

The electrical conductivity of the SWCNT film (electrically conductive carbon film) was 3.4×10⁵ S/m.

The surface sheet resistance of the SWCNT film (electrically conductive carbon film) was 20 Ω/sq.

### Example 2

An electrically conductive film laminate was obtained in the same manner as in example 1 except that an iron nitrate solution (0.52 M) was used instead of the iron chloride solution (6.9 M) as the Cu etchant.

(Evaluation)

The electrical conductivity of the SWCNT film (electrically conductive carbon film) of the electrically conductive film laminate was measured in the same manner as in example 1.

The electrical conductivity of the SWCNT film (electrically conductive carbon film) was 1.4×10⁵ S/m.

The surface sheet resistance of the SWCNT film (electrically conductive carbon film) was 46 Ω/sq.

### Comparative Example 1

An electrically conductive film laminate having the same layer configuration as that of example 1 was obtained using a conventional PMMA-assisted transfer method.

### (First Laminate Manufacturing Step)

[Application Step]

First, the application step was performed as in example 1.

[Removal Step]

Then, the Cu plate on which the CNT coated film was formed was heat-treated at 350° C. for 30 minutes, and thus an electrically conductive carbon film composite in which a 150 nm-thick SWCNT film was formed on the surface of the Cu plate was obtained.

A PMMA adhesive support sheet as the adhesive layer 20 was prepared on the SWCNT film of the electrically conductive carbon film composite using a spin coat method.

First, a PMMA dispersion liquid was prepared. The PMMA dispersion liquid was prepared by mixing a PMMA with ethyl lactate as a solvent. The PMMA dispersion liquid was prepared so as to contain 4 mass % PMMA in 100 mass %.

Then, a coated film of the PMMA dispersion liquid was formed on the SWCNT film of the electrically conductive carbon film composite using a spin coat method, and through a heat treatment at 180° C., a PMMA adhesive support sheet having a thickness of 200 nm was formed on the SWCNT film.

Thus, the first laminate including the Cu plate, the SWCNT film, and the PMMA adhesive support sheet was obtained.

(Etching Step)

The etching tank 200 illustrated in FIG. 9 was prepared, and a Cu etchant of an iron chloride solution (6.9 M) at 20° C. was stored in the tank. When the first laminate was immersed in the Cu etchant for 18 minutes and the Cu plate of the first laminate was removed by etching, an electrically conductive film laminate including the PMMA adhesive support sheet and the SWCNT film was obtained.

(Transfer Step in Water)

A PET plate (thickness: 125 μm, glass transition temperature: 69° C.) was prepared as a substrate to be laminated.

A water tank filled with ultrapure water was prepared. In ultrapure water, the SWCNT film of the electrically conductive film laminate was transferred to the surface of the PET plate, and a transfer body in which the PMMA adhesive support sheet, the SWCNT film, and the PET plate were stacked in this order was prepared.

(Cleaning Step)

Toluene was made to flow down on the transfer body and the PMMA adhesive support sheet was removed from the transfer body, and thus a two-layer conductor having the SWCNT film and the PET plate stacked in this order was obtained.

(Evaluation)

The electrical conductivity was measured for the SWCNT film (electrically conductive carbon film) of the two-layer conductor in the same manner as in example 1.

Note that four Ag terminals were prepared by applying Ag paste to the four corners of the surface on the SWCNT film (electrically conductive carbon film) of the two-layer conductor in the test piece.

The electrical conductivity of the SWCNT film (electrically conductive carbon film) was 7.8×10⁴ S/m.

The surface sheet resistance of the SWCNT film (electrically conductive carbon film) was 85 Ω/sq.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing an electrically conductive film laminate comprising a substrate to be laminated, an adhesive layer formed on a surface of the substrate to be laminated, and an electrically conductive carbon film formed on a surface of the adhesive layer, the method comprising:
a first laminate manufacturing step for manufacturing a first laminate including a forming substrate for forming the electrically conductive carbon film on a surface thereof, the electrically conductive carbon film formed on a surface of the forming substrate, and the adhesive layer formed on a surface of the electrically conductive carbon film;
a thermocompression bonding step for manufacturing a second laminate by bringing the adhesive layer of the first laminate into contact with the substrate to be laminated, and then performing heating and pressure bonding; and
an etching step for manufacturing the electrically conductive film laminate by etching the forming substrate of the second laminate.

2. The method according to claim 1, wherein the electrically conductive carbon film making up the first laminate is an SWCNT film that is a network structure of a single-wall carbon nanotube.

3. The method according to claim 1, wherein a temperature of the heating and pressure bonding in the thermocompression bonding step is a glass transition temperature or higher of the substrate to be laminated.

4. The method according to claim 1, wherein a temperature of the heating and pressure bonding in the thermocompression bonding step is a glass transition temperature or higher of an adhesive making up the adhesive layer.

5. The method according to claim 1, wherein the substrate to be laminated is made from a PET resin.

6. The method according to claim 1, wherein the adhesive layer includes a hardened product of an acrylic-based adhesive.

7. The method according to claim 6, wherein the hardened product of the acrylic-based adhesive is a hardened product of an acrylic-based adhesive having water absorbency.

8. The method according to claim 1, wherein the heating and pressure bonding in the thermocompression bonding step is performed using TOM forming.

9. The method according to claim 1, wherein the forming substrate is a Cu plate made from a Cu-containing metal, and
in the etching step, the second laminate is immersed in an etchant for etching Cu and the forming substrate is etched.

10. The method according to claim 9, wherein the etchant is made from one or both of an iron nitrate solution and an iron chloride solution.

11. The method according to claim 2, wherein the SWCNT film is formed through:
an application step for forming a CNT coated film by applying CNT ink including a single-wall carbon nanotube, a dispersant, and a dispersion solvent onto the forming substrate using a spin coating method; and
a removal step for removing the dispersant and the dispersion solvent from the CNT coated film.

12. The method according to claim 11, wherein in the removal step, the CNT coated film is heat-treated at 350° C. or higher.

13. An electrically conductive film laminate, comprising:
a substrate to be laminated; an adhesive layer formed on a surface of the substrate to be laminated; and an electrically conductive carbon film formed on a surface of the adhesive layer, wherein
the electrically conductive carbon film is an SWCNT film that is a network structure of a single-wall carbon nanotube, and
the adhesive layer includes a hardened product of an adhesive and metal ions.

14. The electrically conductive film laminate according to claim 13, wherein the metal ions include Cu²⁺ and Fe²⁺.
